(19) United States
(12) Patent Application Publication
(10) Pub. No.: US 2022/0092396 A1
(43) Pub. Date: Mar. 24, 2022

(54) PRODUCT-SUM OPERATION DEVICE, LOGICAL OPERATION DEVICE, NEUROMORPHIC DEVICE, AND PRODUCT-SUM OPERATION METHOD

(71) Applicant: TDK CORPORATION, Tokyo (JP)

(72) Inventors: Kuniyasu ITO, Tokyo (JP); Tatsuo SHIBATA, Tokyo (JP); Yukio TERASAKI, Tokyo (JP)

(73) Assignee: TDK CORPORATION, Tokyo (JP)

(21) Appl. No.: 17/420,915

(22) PCT Filed: Jan. 9, 2019
(86) PCT No.: PCT/JP2019/000317

§ 371 Date: Jul. 6, 2021

(51) Int. Cl. G06N 3/063; G06F 7/523; G06F 7/50

(52) U.S. Cl. CPC G06N 3/063; G06F 7/50; G06F 7/523

(57) ABSTRACT

A product-sum operation device including: product operation units generating output signals by multiplying input signals corresponding to input values; a current detection unit executing a current detecting process in which a current output from the product operation units with a predetermined time delay from input of the input signal and a current output from the product operation units at an interval thereafter are detected in a time span from a first transient response to before occurrence of a second transient response, the first transient response due to charging to a parasitic capacitance of the product operation units by input of the input signal and the second transient response being due to discharging from the parasitic capacitance of the product operation units by input of the input signal; and a sum operation unit calculating a value relating to a total sum of the output signals based on currents detected.

### TECHNICAL FIELD

The present invention relates to a product-sum operation device, a logical operation device, a neuromorphic device, and a product-sum operation method.

### BACKGROUND ART

In a conventional neural network, input signals are multiplied by weighting factors, and a value of a total sum thereof is input to an activation function, whereby an output is acquired. Thus, a product-sum operation has been attempted to be realized using an analog circuit by combining two or more memristors of which resistance continuously changes and reading a total sum of current values output therefrom.

In a learning process of a neural network, a memristor assigned to each synapse has resistance value changing such that it has a predetermined weighting factor and maintains this value even when power is cut off. In a inference process, pulse width modulation (PWM) control in which a length of a voltage pulse changes in accordance with a level of input data using a value of a memristor in which information is maintained is used.

For example, in Patent Literature 1, a product-sum operation device in which information written into a resistance-changing-type variable resistance element from a data line and a bit line is stored in a capacitor as an amount of electric charge has been disclosed.

### CITATION LIST

### Patent Literature

### [Patent Literature 1]

Japanese Patent No. 5160304

### SUMMARY OF INVENTION

### Technical Problem

A memristor has a circuit configuration in which a parasitic capacitor and a parasitic resistor are connected in parallel as an equivalent circuit. For this reason, in a case in which an input signal that is a voltage pulse is input to the memristor, a transient response due to charging of the parasitic capacitor and a transient response due to discharging from the parasitic capacitor are generated. Thus, in the product-sum operation device described above, electric charge according to such transient responses is stored in the capacitor in addition to electric charge in a steady state in which such transient responses are not generated, and thus there are cases in which the capacitor becomes saturated, and a product-sum operation is not able to be executed.

An object of the present invention is to provide a product-sum operation device, a logical operation device, a neuromorphic device, and a product-sum operation method capable of avoiding a situation in which a product-sum operation is not able to be executed due to saturation of a capacitor.

### Solution to Problem

According to one aspect of the present invention, there is provided a product-sum operation device including: a plurality of product operation units configured to generate output signals by multiplying input signals corresponding to input values by weighting factors and output the output signals; a current detection unit configured to execute a current detecting process in which a current output from the plurality of product operation units with a predetermined time delay from input of the input signal and a current output from the plurality of product operation units at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal; and a sum operation unit configured to calculate a value relating to a total sum of the output signals based on currents detected at the predetermined time intervals by the current detecting unit.

In addition, in one aspect of the present invention, each of the plurality of product operation units includes a magnetoresistive effect element exhibiting a magnetoresistive effect.

In addition, in one aspect of the present invention, the sum operation unit calculates a product of a total current that is a sum of currents detected at the predetermined time intervals by the current detecting unit and a coefficient time, as the value relating to the total sum of the output signals.

In addition, in one aspect of the present invention, the coefficient time is a shortest length that can be taken by the input signals, the input signals have a length of an integer multiple of the coefficient time and are simultaneously input to the plurality of product operation units, and the current detecting unit executes the current detecting process in a period equal to the coefficient time.

In addition, in one aspect of the present invention, the current detecting unit ends the current detecting process at a time point at which a time equal to a longest length that can be taken by the input signals elapses after the current detecting process is executed for the first time.

In addition, in one aspect of the present invention, the current detecting unit ends the current detecting process in a case in which a current detected in the current detecting process is equal to a current acquired in a case in which no input signal is input to the plurality of product operation units.

In addition, according to one aspect of the present invention, there is provided a logical operation device including any one of the product-sum operation devices described above.

In addition, according to one aspect of the present invention, there is provided a neuromorphic device including any one of the product-sum operation devices described above.

In addition, according to one aspect of the present invention, there is provided a product-sum operation method by the product-sum operation device according to any one of claims 1 to 6, the product-sum method including: a product operation step that is a step of generating output signals by multiplying input signals corresponding to input values by weighting factors and outputting the output signals, using a plurality of product operation units; a current detecting step that is a step of executing a current detecting process in which a current output from the plurality of product operation units with a predetermined time delay from input of the input signal and a current output from the plurality of product operation units at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal; and a sum operation step that is a step calculating a value relating to a total sum of the output signals based on currents detected at the predetermined time intervals in the current detecting step.

### Advantageous Effects of Invention

According to the product-sum operation device, the logical operation device, the neuromorphic device, and the product-sum operation method described above, a product-sum operation device, a logical operation device, a neuromorphic device, and a product-sum operation method capable of avoiding a situation in which a product-sum operation is not able to be executed due to saturation of a capacitor can be provided.

### BRIEF DESCRIPTION OF DRAWINGS

FIG. 1 is a diagram illustrating an example of the configuration of a part of a product-sum operation device according to an embodiment.

FIG. 2 is a diagram illustrating an example of a variable resistance element according to the embodiment.

FIG. 3 is a diagram illustrating an example of an equivalent circuit of the configuration of a part of the product-sum operation device according to the embodiment.

FIG. 4 is a diagram illustrating an example of an input signal input to a product operation unit according to the embodiment.

FIG. 5 is a diagram illustrating an example of an output signal output from the product operation unit according to the embodiment.

FIG. 6 is a diagram illustrating an example of currents input to a current detecting unit according to the embodiment.

FIG. 7 is a diagram for explaining timings at which a current detecting process is executed by the current detecting unit according to the embodiment.

FIG. 8 is a diagram for explaining an example of a neural network operation executed by the product-sum operation device according to the embodiment.

### DESCRIPTION OF EMBODIMENTS

### Embodiment

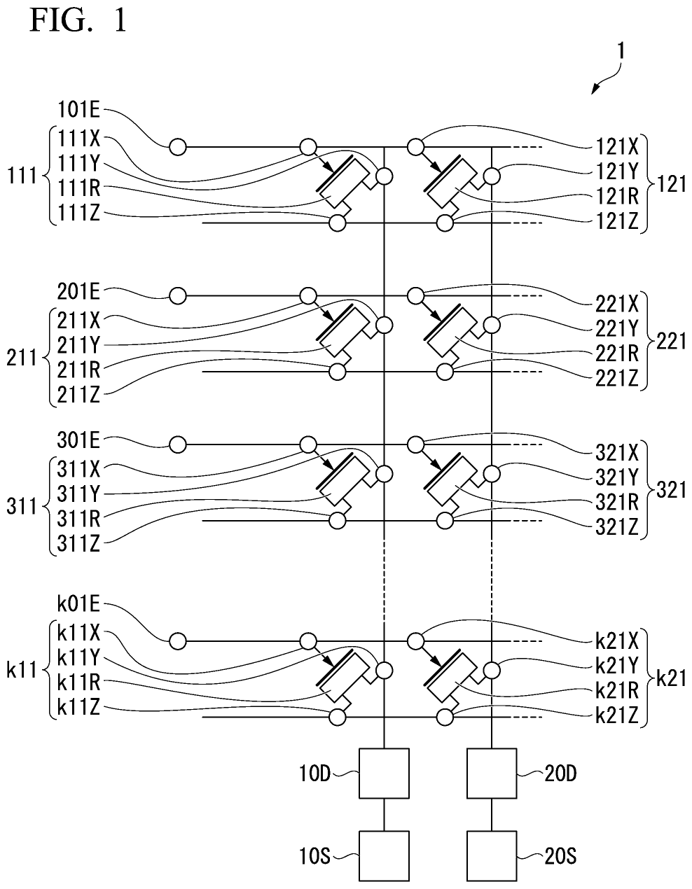

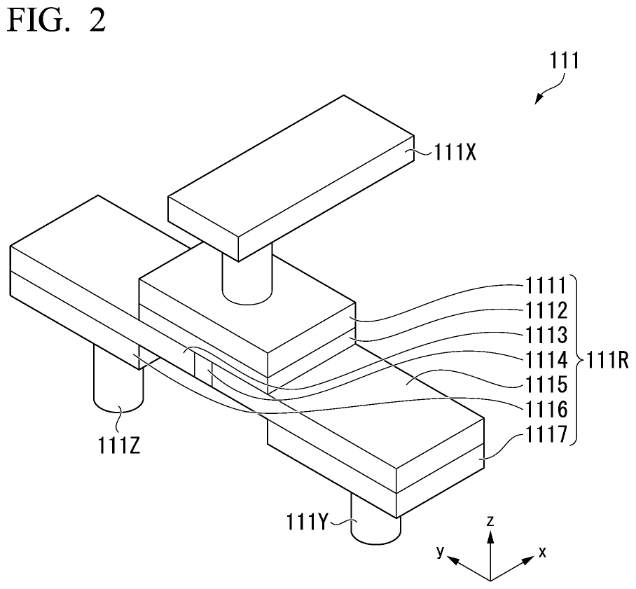

An example of configuration of a product-sum operation device according to an embodiment will be described with reference to FIGS. 1 and 2.

FIG. 1 is a diagram illustrating an example of the configuration of a part of the product-sum operation device according to the embodiment. As illustrated in FIG. 1, the product-sum operation device 1 includes product operation units 111, 121, 211, 221, 311, 321, . . . , k11, k21, input units 101E, 201E, 301E, . . . , k01E, current detecting units 10D and 20D, and sum operation units 10S and 20S.

FIG. 2 is a diagram illustrating an example of a variable resistance element according to the embodiment. The product operation unit 111 is a variable resistance element, for example, a magnetoresistive effect element illustrated in FIG. 2. As illustrated in FIGS. 1 and 2, the product operation unit 111 includes a variable resistor 111R, a read terminal 111X, a common terminal 111Y, and a write terminal 111Z. The product operation units 121, 211, 221, 311, 321, . . . , k11, k21 illustrated in FIG. 1 are variable resistance elements, for example, magnetoresistive effect elements as illustrated in FIG. 2 and respectively include variable resistors 121R, 211R, 221R, 311R, 321R, . . . , k11R, k21R, read terminals 121X, 211X, 221X, 311X, 321X, . . . , k11X, k21X, common terminals 121Y, 211Y, 221Y, 311Y, 321Y, . . . , k11Y, k21Y, and write terminals 121Z, 211Z, 221Z, 311Z, 321Z, . . . , k11Z, k21Z. In the following description, although the product operation unit 111 will be described as an example as is appropriate, the description similarly applies also to the other product operation units 121, 211, 221, 311, 321, . . . , k11, k21.

Here, for example, the variable resistor 111R included in the product operation unit 111, as illustrated in FIG. 2, includes a magnetization fixing layer 1111, a non-magnetic layer 1112, a first region 1113, a magnetic domain wall 1114, a second region 1115, a first magnetization supplying layer 1116, and a second magnetization supplying layer 1117. Hereinafter, in description with reference to FIG. 2, an x axis, a y axis, and a z axis illustrated in FIG. 2 will be used. The x axis, the y axis, and the z axis form three-dimensional orthogonal coordinates of a right-handed type. The magnetization fixing layer 1111, the non-magnetic layer 1112, the first region 1113, the second region 1115, the first magnetization supplying layer 1116, and the second magnetization supplying layer 1117 are formed in a thin parallelepiped shape in the z-axis direction, and a largest area is parallel to an xy plane, and the first region 1113 and the second region 1115 are electrically and magnetically connected to each other. While the magnetization fixing layer 1111, the non-magnetic layer 1112, the first region 1113, the second region 1115, the first magnetization supplying layer 1116, and the second magnetization supplying layer 1117 are stacked in the mentioned order in a direction from a +z side to a −z side, the stacking direction may be reversed. In a case in which a direction in which these are stacked is reversed, the read terminal 111X is disposed on the −z side, and the common terminal 111Y and the write terminal 111Z are disposed on the +Z side.

The magnetization direction of the magnetization fixing layer 1111 is fixed in the +z direction or the −z direction. Here, the magnetization being fixed means that the magnetization direction does not change at the time of an initial period for introducing the magnetic domain wall 1114 and before and after writing using a write current. In addition, for example, the magnetization fixing layer 1111 may be an in-plane magnetization film having in-plane magnetic anisotropy or a vertical magnetization film having vertical magnetic anisotropy.

The non-magnetic layer 1112 has a face directed in the +z direction being in contact with a face of the magnetization fixing layer 1111 that is directed in the −z direction and a face directed in the −z direction being in contact with the first region 1113 and the second region 1115. As illustrated in FIG. 2, a face of the magnetization fixing layer 1111 directed in the −z side and a face of the non-magnetic layer 1112 directed in the +z side have the same shape and the same area. Here, the non-magnetic layer 1112 may be configured to extend to cover a face of the first region 1113 directed in the +z direction and a face of the second region 1115 directed in the +z direction more widely than that of the case illustrated in FIG. 2. In addition, the non-magnetic layer 1112 is used for the product operation unit 111 to read a change in the magnetization state of a magnetization free layer with respect to the magnetization fixing layer 1111 as a change in the resistance value.

The first region 1113, the magnetic domain wall 1114, and the second region 1115 form a magnetization free layer. The magnetization free layer is produced using a ferromagnetic material. A magnetization direction of the first region 1113 and a magnetization direction of the second region 1115 are opposite to each other in a direction parallel to the z axis. The magnetic domain wall 1114 is interposed between the first region 1113 and the second region 1115 in a direction parallel to the y axis.

The first magnetization supplying layer 1116 preferably does not overlap the magnetization fixing layer 1111 in a direction parallel to the z axis and has a face directed in the +z direction to be in contact with a face of the first region 1113 directed in the −z direction. The first magnetization supplying layer 1116 has a function of fixing a magnetization direction of a range of the first region 1113 that overlaps the first magnetization supplying layer 1116 in a direction parallel to the z axis to a desired direction. Furthermore, the write terminal 111Z is connected to a face of the first magnetization supplying layer 1116 directed in the −z direction. For example, the first magnetization supplying layer 1116 is produced using the same material as a ferromagnetic material that can be used for the magnetization fixing layer 1111, an antiferromagnetic body of IrMn or the like, a ferromagnetic body having a nonmagnetic intermediate layer of Ru, Ir, or the like interposed therebetween, or a material having a synthetic antiferromagnetic structure including a nonmagnetic body and a ferromagnetic body.

The second magnetization supplying layer 1117 preferably does not overlap the magnetization fixing layer 1111 in a direction parallel to the z axis and has a face directed in the +z direction being in contact with a face of the second region 1115 directed in the −z direction. The second magnetization supplying layer 1117 has a function of fixing a magnetization direction of a range of the second region 1115 that overlaps the second magnetization supplying layer 1117 in a direction parallel to the z axis to a desired direction. Furthermore, the common terminal 111Y is connected to a face of the second magnetization supplying layer 1117 directed in the −z direction. For example, the first magnetization supplying layer 1116 is produced using the same material as a ferromagnetic material that can be used for the magnetization fixing layer 1111, an antiferromagnetic body of IrMn or the like, a ferromagnetic body having a nonmagnetic intermediate layer of Ru, Ir, or the like interposed therebetween, or a material having a synthetic antiferromagnetic structure including a nonmagnetic body and a ferromagnetic body.

In the variable resistor 111R, each of the magnetization directions of the magnetization fixing layer 1111, the first region 1113, the second region 1115, the first magnetization supplying layer 1116, and the second magnetization supplying layer 1117 may be not only a direction parallel to the z axis but also a direction parallel to the x axis or a direction parallel to the y axis. Also in such a case, it is preferable that the magnetization direction of the magnetization fixing layer 1111 and the magnetization directions of the first region 1113, the second region 1115, the first magnetization supplying layer 1116, and the second magnetization supplying layer 1117 are parallel to each other. For example, in a case in which the magnetization direction of the magnetization fixing layer 1111 is the +y direction, the magnetization direction of the first region 1113 is the +y direction, the magnetization direction of the second region 1115 is the −y direction, the magnetization direction of the first magnetization supplying layer 1116 is the +y direction, and the magnetization direction of the second magnetization supplying layer 1117 is the −y direction.

The product operation unit 111 changes the position of the magnetic domain wall 1114 in a direction parallel to the y axis by adjusting a magnitude and a time of a write current flowing between the common terminal 111Y and the write terminal 111Z. In accordance with this, the product operation unit 111 can change the resistance value of the variable resistor 111R approximately linearly by continuously changing an area ratio between an area in which the magnetization directions are parallel and an area in which the magnetization directions are antiparallel. Here, the area in which the magnetization directions are parallel is an area of a part of the first region 1113 that overlaps the magnetization fixing layer 1111 in a direction parallel to the z axis. In addition, the area in which the magnetization directions are antiparallel is an area of a part of the second region 1115 that overlaps the magnetization fixing layer 1111 in a direction parallel to the z axis. A write current is input to the write terminal 111Z. A magnitude and a time of the write current are adjusted by at least one of the number and the time of current pulses.

The product operation units 111, 121, 211, 221, 311, 321, . . . , k11, k21 may be tunnel magnetoresistive effect elements. A tunnel magnetoresistive effect element includes a magnetization fixing layer, a magnetization free layer, and a tunnel barrier layer as a nonmagnetic layer. The magnetization fixing layer and the magnetization free layer are produced using ferromagnetic materials and have magnetization. The tunnel barrier layer is interposed between the magnetization fixing layer and the magnetization free layer. The tunnel magnetoresistive effect element can change a resistance value by changing a relation between the magnetization of the magnetization fixing layer and the magnetization of the magnetization free layer.

Referring back to FIG. 1, the input unit 101E is connected to the read terminals 111X and 121X. Similarly, the input unit 201E is connected to the read terminals 211X and 221X illustrated in FIG. 1, the input unit 301E is connected to the read terminals 311X and 321X, and the input unit k01E is connected to the read terminals k11X and k21X.

The input unit 101E inputs an input signal corresponding to an input value to the read terminals 111X and 121X. Similarly, the input unit 201E inputs an input signal corresponding to an input value to the read terminals 211X and 221X. The input unit 301E inputs an input signal corresponding to an input value to the read terminals 311X and 321X. The input unit k01E inputs an input signal corresponding to an input value to the read terminals k11X and k21X. All these input signals are voltage signals for which pulse width modulation (PWM) corresponding to input values is performed.

The product operation unit 111 generates an output signal by multiplying an input signal corresponding to an input value by a weighting factor and outputs the output signal. In other words, the product operation unit 111 reads a resistance value of the variable resistor 111R as a weighting factor, executes a product operation on an input signal input to the read terminal 111X to generate an output signal, and outputs the output signal from the common terminal 111Y. Similarly, each of the product operation units 121, 211, 221, 311, 321, . . . , k11, k21 multiplies an input signal corresponding to an input value by a weighting factor to generate an output signal and outputs the output signal.

The current detecting unit 10D executes a current detecting process in which a current output from the plurality of product operation units with a predetermined time delay from input of the input signal and a current output from the product operation units 111, 211, 311, . . . , k11 at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal. Similarly, the current detecting unit 20D executes a current detecting process in which a current output from the plurality of product operation units with a predetermined time delay from input of the input signal and a current output from the product operation units 121, 221, 321, k21 at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal. Details of the current detecting units 10D and 20D will be described later.

The sum operation unit 10S calculates a value relating to a total sum of output signals based on currents detected at predetermined time intervals by the current detecting unit 10D. Similarly, the sum operation unit 20S calculates a value relating to a total sum of output signals based on currents detected at predetermined time intervals by the current detecting unit 20D. Details of the sum operation units 10S and 20S will be described later.

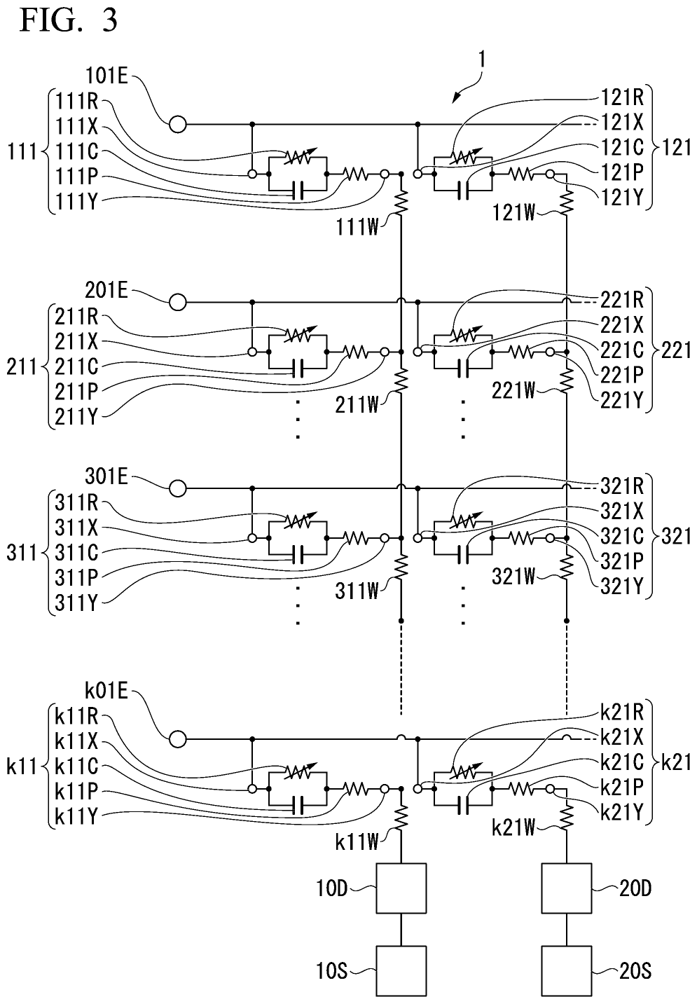

Next, an example of a process executed by a product-sum operation device according to an embodiment will be described with reference to FIGS. 3 to 6.

FIG. 3 is a diagram illustrating an example of an equivalent circuit of the configuration of a part of the product-sum operation device according to the embodiment. As illustrated in FIG. 3, the product operation unit 111 includes a parasitic capacitor 111C and a parasitic resistor 111P as an equivalent circuit of a magnetoresistive effect element and may be assumed such that the parasitic capacitor 111C is connected to the variable resistor 111R in parallel, and the parasitic resistor 111P is connected to the variable resistor 111R in series. Similarly, the product operation units 121, 211, 221, 311, 321, k11, k21 respectively include parasitic capacitors 121C, 211C, 221C, 311C, 321C, . . . , k11C, k21C and parasitic resistors 121P, 211P, 221P, 311P, 321P, . . . , k11P, k21P. In addition, wiring resistors 111W, 121W, 211W, 221W, 311W, 321W, . . . , k11W, k21W can be assumed to be respectively connected to the product operation units 111, 121, 211, 221, 311, 321, . . . , k11, k21 in series.

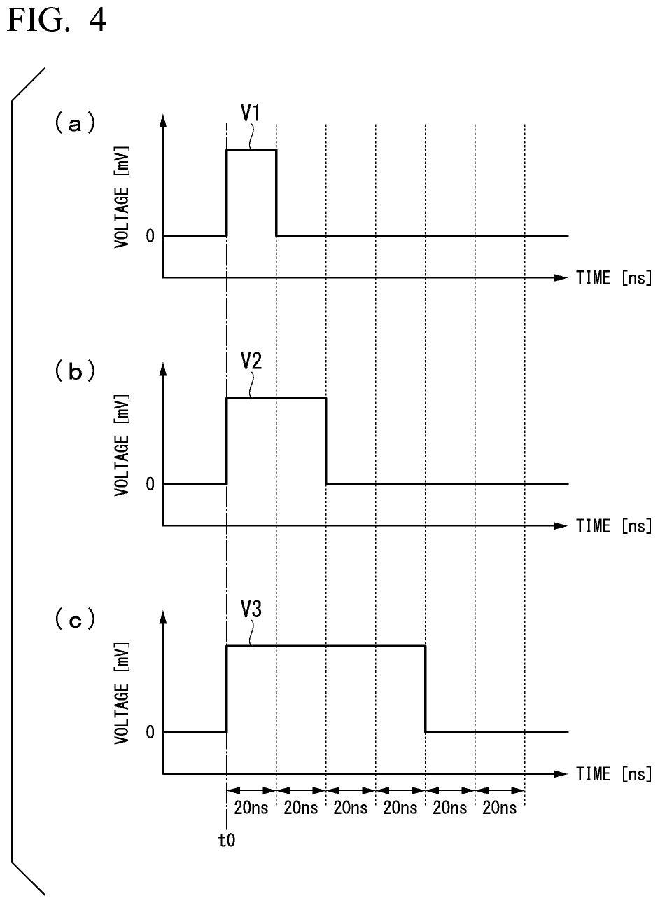

FIG. 4 is a diagram illustrating an example of an input signal input to the product operation unit according to the embodiment. The input unit 101E, for example, outputs an input signal V1 illustrated in FIG. 4(a). Similarly, the input unit 201E, for example, outputs an input signal V2 illustrated in FIG. 4(b). In addition, the input unit 301E, for example, outputs an input signal V3 illustrated in FIG. 4(c).

For example, the input signal V1 is a voltage pulse having a length of 20 [ns] as a coefficient time and a pulse height of 0.1 mV. This 20 [ns] is an example of a shortest length that can be taken by the input signal. The input signal V2 is a voltage pulse having a length of 40 [ns] that is twice the coefficient time described above and a pulse height of 0.1 mV. The input signal V3 is a voltage pulse having a length of 80 [ns] that is four times the length of the coefficient time described above and a pulse height of 0.1 mV. A time at which the input signal V1 is input to the product operation unit 111, a time at which the input signal V2 is input to the product operation unit 211, and a time at which the input signal V3 is input to the product operation unit 311, as illustrated in FIG. 4, are a time t0. In other words, the input signal V1, the input signal V2, and the input signal V3 are simultaneously input respectively to the product operation units 111, 211, and 321.

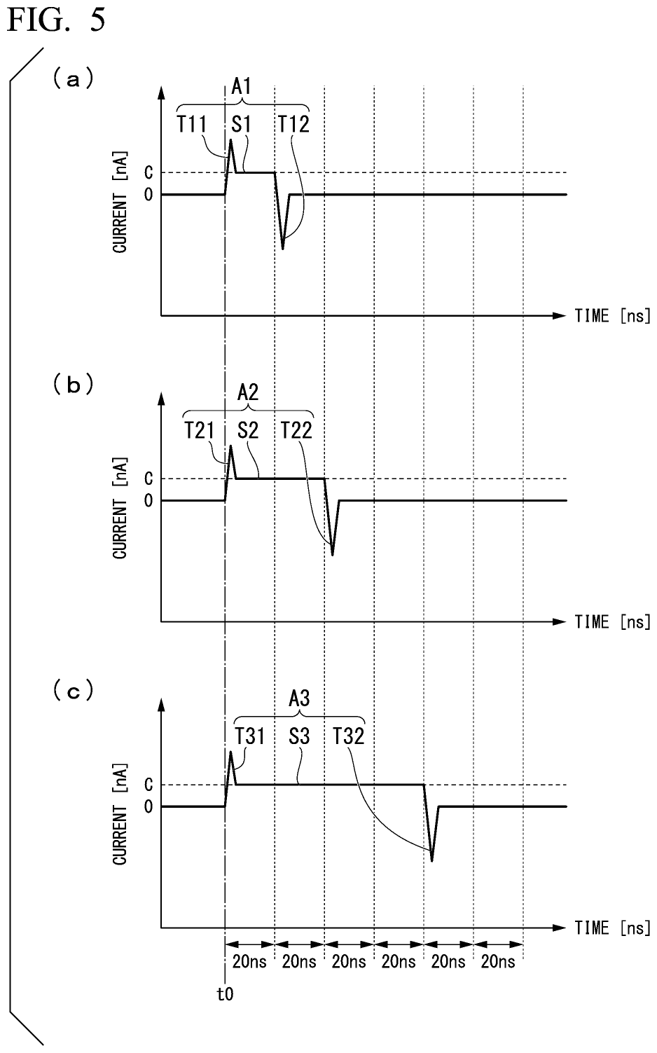

FIG. 5 is a diagram illustrating an example of an output signal output from the product operation unit according to the embodiment. In a case in which the input signal V1 illustrated in FIG. 4(a) is input to the product operation unit 111, an output signal A1 illustrated in FIG. 5(a) is input to the current detecting unit 10D. Similarly, in a case in which the input signal V2 illustrated in FIG. 4(b) is input to the product operation unit 211, an output signal A2 illustrated in FIG. 5(b) is input to the current detecting unit 10D. In addition, in a case in which the input signal V3 illustrated in FIG. 4(c) is input to the product operation unit 311, an output signal A3 illustrated in FIG. 5(c) is input to the current detecting unit 10D. In the following description, a case in which differences between the capacitance values of the parasitic capacitors 111C, 211C, and 311C are substantially ignorable will be described as an example.

The output signal A1 illustrated in FIG. 5(a) is a current signal that includes a first transient response T11, a steady part S1 and a second transient response T12. The first transient response T11 is a transient response due to charging of the parasitic capacitor 111C of the product operation unit 111 according to the input of the input signal V1. The steady part S1 is a part of the output signal A1 in which a steady current C [nA] flows between a time point at which generation of the first transient response T11 ends and a time point at which generation of the next second transient response T12 starts. The second transient response T12 is a transient response due to discharging from the parasitic capacitor 111C of the product operation unit 111 according to the input of the input signal V1. A length of the first transient response T11 and a length of the second transient response T12 are short enough to be ignorable with respect to a length of the steady part S1. A length of the output signal A1 is in the same level as a time acquired by adding a transient response due to discharging from the parasitic capacitor 111C to 20 [ns] that is a length of the input signal V1.

The output signal A2 illustrated in FIG. 5(b) is a current signal that includes a first transient response T21, a steady part S2 and a second transient response T22. The first transient response T21 is a transient response due to charging of the parasitic capacitor 211C of the product operation unit 211 according to the input of the input signal V1. The steady part S2 is a part of the output signal A2 in which a steady current [nA] flows between a time point at which generation of the first transient response T21 ends and a time point at which generation of the next second transient response T22 starts. The second transient response T22 is a transient response due to discharging from the parasitic capacitor 211C of the product operation unit 211 according to the input of the input signal V2. A length of the first transient response T21 and a length of the second transient response T22 are short enough to be ignorable with respect to a length of the steady part S2. A length of the output signal A2 is in the same level as a time acquired by adding a transient response due to discharging from the parasitic capacitor 211C to 40 [ns] that is a length of the input signal V2.

The output signal A3 illustrated in FIG. 5(c) is a current signal that includes a first transient response T31, a steady part S3 and a second transient response T32. The first transient response T31 is a transient response due to charging of the parasitic capacitor 311C of the product operation unit 311 according to the input of the input signal V3. The steady part S3 is a part of the output signal A3 in which a steady current C [nA] flows between a time point at which generation of the first transient response T31 ends and a time point at which generation of the next second transient response T32 starts. The second transient response T32 is a transient response due to discharging from the parasitic capacitor 311C of the product operation unit 311 according to the input of the input signal V3. A length of the first transient response T31 and a length of the second transient response T32 are short enough to be ignorable with respect to a length of the steady part S3. A length of the output signal A3 is in the same level as a time acquired by adding a transient response due to discharging from the parasitic capacitor 311C to 80 [ns] that is a length of the input signal V3.

In a case that differences in the capacitance values of the parasitic capacitors 111C, 211C, and 311C are substantially ignorable, the first transient response T11, the first transient response T21, and the first transient response T31 are transient responses of which lengths and heights are almost the same, and the second transient response T12, the second transient response T22, and the second transient response T32 are transient responses of which lengths and heights are almost the same.

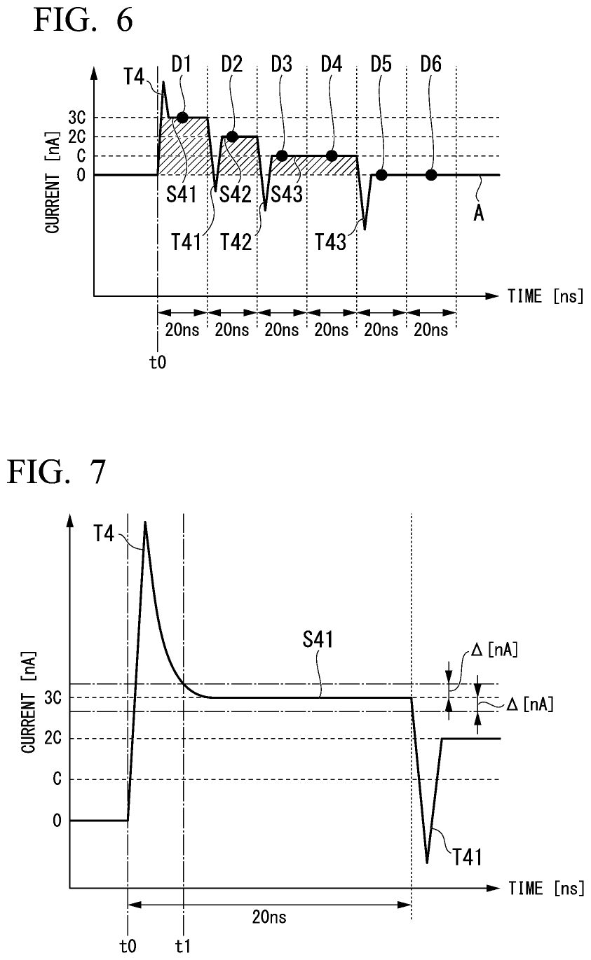

FIG. 6 is a diagram illustrating an example of currents input to the current detecting unit according to the embodiment. In a case in which the input signal V1, the input signal V2, and the input signal V3 illustrated in FIG. 4 are simultaneously input respectively to the product operation units 111, 211, and 311, a current signal A is input to the current detecting unit 10D. As illustrated in FIG. 6, the current signal A includes a first transient response T4, a steady part S41, a second transient response T41, a steady part S42, a second transient response T42, a steady part S43, and a second transient response T43.

The first transient response T4 is a transient response that is generated by adding the first transient response T11, the first transient response T21, and the first transient response T31 illustrated in FIG. 5 together. The steady part S41 is a part in which a steady current 3C [nA] flows by adding the steady part S1, the steady part S2, and the steady part S3 illustrated in FIG. 5 together.

The second transient response T41 is a transient response that is generated by adding the steady part S2 and the steady part S3 to the second transient response T12 illustrated in FIG. 5. The steady part S42 is a part in which a steady current 2C [nA] flows by adding the steady part S2 and the steady part S3 illustrated in FIG. 5 together. The second transient response T42 is a transient response that is generated by adding the steady part S3 to the second transient response T22 illustrated in FIG. 5. Similar to the steady part S3, the steady part S43 is a part in which a steady current 1C [nA] flows. The second transient response T43 is the second transient response T32 illustrated in FIG. 5.

The current detecting unit 10D executes a current detecting process of detecting currents output by the product operation units 111, 211, and 311 for every coefficient time between a time point at which the generation of the first transient response or the second transient response described above ends and a time point at which the generation of the next first transient response or the second transient response starts. The coefficient time described here, for example, is a period corresponding to the steady part S41, the steady part S42, and the steady part S43 illustrated in FIG. 6.

For example, as denoted by a point D1 in FIG. 6, the current detecting unit 10D detects a current 3C [nA] at a time point delayed by a coefficient time, for example, 10 [ns], from a time t0 for the first time. Then, as denoted by a point D2, a point D3, a point D4, a point D5, and a point D6 in FIG. 6, the current detecting unit 10D, detects currents 2C [nA], 1C [nA], 1C [nA], 0 [nA], and 0 [nA] at the coefficient time described above, for example, at the period of 20 [ns].

In addition, in a case in which a current detected in the current detecting process is the same as a current of a case in which no input signal is input to the product operation units 111, 211, 311, . . . , k11, the current detecting unit 10D ends the current detecting process. For example, as denoted by the point D5 in FIG. 6, in a case in which a current 0 [nA] is detected at the fifth period, the current detecting unit 10D stops the current detecting process at the 6th period point D6 and at the 7th period and thereafter.

Alternatively, the current detecting unit 10D ends the current detecting process at a time point at which a time that is equal to a longest length that can be taken by an input signal elapses after the current detection process is executed for the first time. For example, in a case in which the length of an input signal can take one of one time, two times, three times, . . . , 254 times, 255 times, and 256 times that of a shortest length of the input signal, the current detecting unit 10D stops the current detecting process at the 257-th period and thereafter.

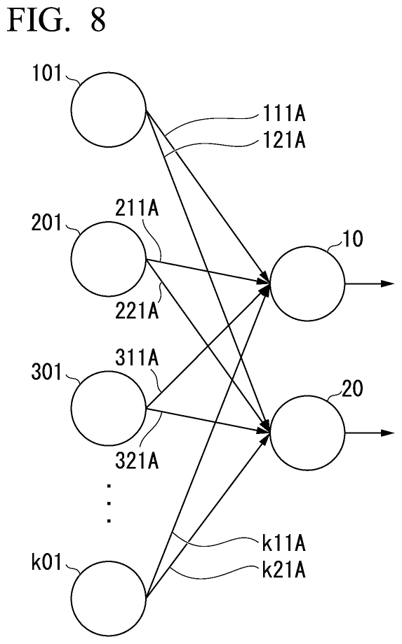

In the example described with reference to FIGS. 3 to 6, although the current detecting process is executed at a time point at which 10 [ns] has elapsed from a start time point of each period, the current detecting process may be executed at another timing. FIG. 7 is a diagram for explaining timings at which the current detecting process is executed by the current detecting unit according to the embodiment.

For example, a case in which, at a time t0, the input signal V1 is input to the product operation unit 111, the input signal V2 is input to the product operation unit 211, and the input signal V3 is input to the product operation unit 311 will be considered. In this case, as described with reference to FIG. 6, the first transient response T4 is generated. As illustrated in FIG. 7, the first transient response T4, after reaching a current higher than the current 3C [nA], converges at the current 3C [nA].

A state in which the magnitude of the current has entered the range of 3C-Δ [nA] to 3C+Δ[nA] is a steady state in which a steady current flows. For example, the magnitude of Δ [nA] is preferably 10 % p-p of the current 3 [nA] and is more preferably 5% p-p of the current 3 [nA].

For example, as illustrated in FIG. 7, the magnitude of the current enters the range at a time t1 . A time interval from the time t0 to the time t1 is called a convergence time. For example, the convergence time is five times a time constant i=RC (R: the resistance value of the parasitic resistor of the product operation unit described above, C: static capacitance of the parasitic capacitor of the product operation unit described above). The resistance value R of the parasitic resistor and the static capacitance C can be calculated by inputting a plurality of rectangular voltage pulses having mutually-different pulse lengths to at least one of the product operation units 111, 211, 311, . . . , k11 and evaluating transient response characteristics.

The convergence time of the first transient response described above is equal to a time required for discharging from the parasitic capacitor and also can be calculated using the following Equation (1).

[Math. 1]

t=−C×R×ln(V1/V0) (1)

In addition, the convergence time of the second transient response described above is equal to a time required for discharging from the parasitic capacitor and also can be calculated using the following Equation (2).

[Math. 2]

t=−C×R×ln(1−V1/V0) (2)

Meanwhile, the second transient response T41 starts to be generated at a time 20 [ns]. Thus, the steady part 41 described above occurs in a period from the time t1 to a time 20 [ns]. The current detecting unit 10D executes a current detecting process at an arbitrary timing in the period of the steady part 41, in other words, from the time t1 to a time 20 [ns]. In addition, by determining the time such that a period from the time t1 to the time 20 [ns] is longer than the convergence time calculated using the time constant described above, the current detecting unit 10D can reliably execute the current detecting process in the steady part 41.

The current acquired using the current detecting process executed by the current detecting unit 10D may be converted into digital data through analog-digital conversion and be stored in a storage medium. In addition, the current detecting unit 10D may detect a current of a predetermined time in a period from a time at which the first transient response converges to form a steady state to a time before generation of the second transient response or may detect a current during a predetermined period. Furthermore, in a case in which a current during a predetermined period is detected, the current detecting unit 10D may set a statistical value of the detected current, for example, an average value or a median value thereof as a result of the current detecting process.

The sum operation unit 10S calculates a product of a sum current that is a sum of currents detected at predetermined time intervals by the current detecting unit 10D and the coefficient time as a value relating to a total sum of output signals.

For example, the sum operation unit 10S calculates a sum current 7 [nA] of currents 3C [nA], 2C [nA], C [nA], C [nA], 0 [nA], and 0 [nA] detected at times denoted by the point D1, the point D2, the point D3, the point D4, the point D5, and the point D6 illustrated in FIG. 6. Then, the sum operation unit 10S calculates a product of the sum current 7 [nA] and 20 [ns] that is an example of the coefficient time as a value relating to a total sum of the output signals. Alternatively, the sum operation unit 10S calculates a value relating to a total sum of output signals by multiplying the currents 3C [nA], 2C [nA], C [nA], C [nA], 0 [nA], and 0 [nA] by 20 [ns] that is an example of the coefficient time and then calculating a total sum of the six products. The value relating to a total sum of output signals calculated using these two methods corresponds to the area of a hatched region in FIG. 6 and is in proportion to a total sum of the output signals.

Details described with reference to FIGS. 3 to 7 are similar also for the product operation units 121, 221, and 321, the current detecting unit 20D, and the sum operation unit 20S.

Next, an example of a neural network operation executed by the product-sum operation device according to this embodiment will be described with reference to FIG. 8. FIG. 8 is a diagram for explaining an example of a neural network operation executed by the product-sum operation device according to the embodiment.

Nodes 101, 201, 301, . . . , k01 form an input layer. Perceptrons 10 and 20 form a hidden layer or an output layer. The node 101 corresponds to the input unit 101E illustrated in FIGS. 1 and 3 and outputs an input value corresponding to an input signal to the perceptrons 10 and 20. Similarly, the nodes 201, 301, . . . , k01 correspond to the input units 201E, 301E, . . . , k01E and output input values corresponding to input signals to the perceptrons 10 and 20.

An arrow 111A corresponds to the product operation unit 111 and represents that an input value output by the node 101 is multiplied by a weighting factor, and a value corresponding to an output signal is input to the perceptron 10. Similarly, an arrow 121A corresponds to the product operation unit 121 and represents that an input value output by the node 101 is multiplied by a weighting factor, and a value corresponding to an output signal is input to the perceptron 20. These similarly apply also to arrows 211A, 221A, 311A, 321A, . . . , k11A, k21A.

The perceptron 10 corresponds to the current detecting unit 10D and the sum operation unit 10S illustrated in FIGS. 1 and 3, executes the current detecting process described above on a signal acquired by adding output signals output from the arrows 111A, 211A, 311A, . . . , k11A together, and calculates a value corresponding to a total sum of the output signals. Then, the perceptron 10 performs an activation function process on the value and outputs a result thereof.

As above, the product-sum operation device 1 according to the embodiment has been described. The product-sum operation device 1 does not need to include a capacitor that stores electric charge for calculating a value relating to a total sum of output signals based on currents detected at predetermined time intervals. Thus, the product-sum operation device 1 can avoid that the capacitor is saturated, and a product sum operation cannot be executed. Since the capacitor can be omitted in the product-sum operation device 1, space saving and cost saving can be realized by reducing the circuit scale.

In addition at least one of the product operation units 111, 121, 211, 221, 311, 321, . . . , k11, k21 included in the product-sum operation device 1 includes a magnetoresistive effect element exhibiting a magnetoresistive effect. The magnetoresistive effect element has higher parasitic capacitance than that of the other variable resistance elements and thus can more easily cause the saturation of the capacitor according to a transient response to occur than the other variable resistance elements. Thus, in a case in which a magnetoresistive effect element is included as the product operation unit described above, the effects described above are particularly useful.

In addition, in the product-sum operation device 1, input signals have lengths that are integer multiples of the coefficient time, which is a shortest length that can be taken, and are simultaneously input respectively to the product operation units 111, 121, 211, 221, 311, 321, . . . , k11, k21. Then, the product-sum operation device 1 executes the current detecting process in the same period as that of the coefficient time. Thus, the product-sum operation device 1 can reliably detect a current in a case in which the first transient response and the second transient response reliably converge to form a steady state and can execute an accurate product sum operation.

In addition, the product-sum operation device 1 ends the current detecting process at a time point at which a time equal to the longest length that can be taken by input signals has elapsed after the current detecting process is executed for the first time. For this reason, the product-sum operation device 1 can set a time in which the current detecting process is executed to be constant and can simply the process.

In addition, the product-sum operation device 1 ends the current detecting process in a case in which a current detected in the current detecting process is equal to a current acquired in a case in which no input signal is input to a plurality of the product operation units 111, 121, 211, 221, 311, 321, . . . , k11, k21. For this reason, the product-sum operation device 1 can end the current detecting process early.

In the embodiment described above, although a case in which the time at which the input signal V1 is input to the product operation unit 111, the time at which the input signal V2 is input to the product operation unit 211, and the time at which the input signal V3 is input to the product operation unit 311 are the time t0 has been described as an example, the configuration is not limited thereto. In other words, the times at which these three input signals are input may be different from each other. In such a case, the coefficient time may be a period from a time point at which generation of the first transient response or the second transient response ends to a time point at which generation of the next first transient response starts.

The product-sum operation device 1 described above may be included in a logical operation device or a neuromorphic device. The logical operation device described here is a logical circuit, for example, such as an AND circuit or an OR circuit that is formed by combining a plurality of product-sum operation devices 1. In addition, a logical operation described here has a concept that includes deep learning. Furthermore, the neuromorphic device described here is a device that applies the structure of the brain and a structure in which nerve cells called neurons ignite and is used for machine learning and the like.

A program used for realizing the function of each device such as the product-sum operation device 1 according to the embodiment described above may be recorded on a computer-readable recording medium, and a computer system may be caused to read and execute the program recorded on this recording medium for performing the process.

The computer system described here may include an operating system (OS) and hardware such as peripherals. The computer-readable recording medium, for example, includes a writable nonvolatile memory such as a floppy dick, a magneto-optical disk, a read only memory (ROM), or a flash memory, a portable medium such as a digital versatile disc (DVD), and a storage device such as a hard disk built into the computer system and includes a medium storing a program for a predetermined time such as an internal volatile memory of a computer system serving as a server or a client in a case in which the program is transmitted through a network or a communication line.

Furthermore, the program described above may be transmitted from a computer system storing the program in a storage device or the like to another computer system through a transmission medium or using transmission waves in a transmission medium. Here, the transmission medium transmitting the program represents a medium having a function of transmitting information such as a network including the Internet and the like or a communication line including a telephone line and the like.

In addition, the program described above may be used for realizing some of the functions described above and may be a program realizing the functions described above by being combined with a program recorded in the computer system in advance, a so-called a differential program. The program described above, for example, is read and executed by a processor such as a central processing unit (CPU) included in a computer.

While a preferred embodiment of the present invention has been described in detail with reference to the drawings, a specific configuration is not limited to such an embodiment, and various modifications and substitutions can be made within a range not departing from the concept of the present invention. The components described in the embodiments described above may be combined.

### REFERENCE SIGNS LIST

1 product-sum operation device

111, 121, 211, 221, 311, 321, k11, k21 product operation unit

10D, 20D current detecting unit

10S, 20S sum operation unit

1-9. (canceled)

10. A product-sum operation device comprising:
a plurality of product operation units configured to generate output signals by multiplying input signals corresponding to input values by weighting factors and output the output signals;
a current detection unit configured to execute a current detecting process in which a current output from the plurality of product operation units with a predetermined time delay from input of the input signal and a current output from the plurality of product operation units at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal; and
a sum operation unit configured to calculate a value relating to a total sum of the output signals based on currents detected at the predetermined time intervals by the current detecting unit.

11. The product-sum operation device according to claim 10, wherein each of the plurality of product operation units includes a magnetoresistive effect element exhibiting a magnetoresistive effect.

12. The product-sum operation device according to claim 10, wherein the sum operation unit calculates a product of a total current that is a sum of currents detected at the predetermined time intervals by the current detecting unit and a coefficient time, as the value relating to the total sum of the output signals.

13. The product-sum operation device according to claim 11, wherein the sum operation unit calculates a product of a total current that is a sum of currents detected at the predetermined time intervals by the current detecting unit and a coefficient time, as the value relating to the total sum of the output signals.

14. The product-sum operation device according to claim 12,
wherein the coefficient time is a shortest length that can be taken by the input signals,
wherein the input signals have a length of an integer multiple of the coefficient time and are simultaneously input to the plurality of product operation units, and
wherein the current detecting unit executes the current detecting process in a period equal to the coefficient time.

15. The product-sum operation device according to claim 13,
wherein the coefficient time is a shortest length that can be taken by the input signals,
wherein the input signals have a length of an integer multiple of the coefficient time and are simultaneously input to the plurality of product operation units, and
wherein the current detecting unit executes the current detecting process in a period equal to the coefficient time.

16. The product-sum operation device according to claim 10, wherein the current detecting unit ends the current detecting process at a time point at which a time equal to a longest length that can be taken by the input signals elapses after the current detecting process is executed for the first time.

17. The product-sum operation device according to claim 11, wherein the current detecting unit ends the current detecting process at a time point at which a time equal to a longest length that can be taken by the input signals elapses after the current detecting process is executed for the first time.

18. The product-sum operation device according to claim 12, wherein the current detecting unit ends the current detecting process at a time point at which a time equal to a longest length that can be taken by the input signals elapses after the current detecting process is executed for the first time.

19. The product-sum operation device according to claim 13, wherein the current detecting unit ends the current detecting process at a time point at which a time equal to a longest length that can be taken by the input signals elapses after the current detecting process is executed for the first time.

20. The product-sum operation device according to claim 10, wherein the current detecting unit ends the current detecting process in a case in which a current detected in the current detecting process is equal to a current acquired in a case in which no input signal is input to the plurality of product operation units.

21. The product-sum operation device according to claim 11, wherein the current detecting unit ends the current detecting process in a case in which a current detected in the current detecting process is equal to a current acquired in a case in which no input signal is input to the plurality of product operation units.

22. The product-sum operation device according to claim 12, wherein the current detecting unit ends the current detecting process in a case in which a current detected in the current detecting process is equal to a current acquired in a case in which no input signal is input to the plurality of product operation units.

23. A logical operation device comprising the product-sum operation device according to claim 10.

24. A logical operation device comprising the product-sum operation device according to claim 11.

25. A logical operation device comprising the product-sum operation device according to claim 12.

26. A neuromorphic device comprising the product-sum operation device according to claim 10.

27. A neuromorphic device comprising the product-sum operation device according to claim 11.

28. A neuromorphic device comprising the product-sum operation device according to claim 12.

29. A product-sum operation method by the product-sum operation device according to claim 10, the product-sum method comprising:
a product operation step that is a step of generating output signals by multiplying input signals corresponding to input values by weighting factors and outputting the output signals, using a plurality of product operation units;
a current detecting step that is a step of executing a current detecting process in which a current output from the plurality of product operation units with a predetermined time delay from input of the input signal and a current output from the plurality of product operation units at a predetermined time interval thereafter are detected in a time span from a first transient response being converged to a steady state to before occurrence of a second transient response, the first transient response being due to charging to a parasitic capacitance of the product operation units by input of the input signal and the second transient response being due to discharging from the parasitic capacitance of the product operation units by input of the input signal; and
a sum operation step that is a step calculating a value relating to a total sum of the output signals based on currents detected at the predetermined time intervals in the current detecting step.
